(19) United States
(12) Patent Application Publication
(10) Pub. No.: US 2024/0161016 A1
(43) Pub. Date: May 16, 2024

(54) OBJECTIVE DETECTION IN A MULTI-TENANT LEAD SCORING SYSTEM

(71) Applicant: Freshworks Inc., San Mateo, CA (US)

(72) Inventors: Rahul Kumar SHARMA, Gurgaon (IN); Swaminathan PADMANABHAN, Chennai (IN); Abhinav KADARI, Visakhapatnam (IN)

(73) Assignee: Freshworks Inc., San Mateo, CA (US)

(21) Appl. No.: 18/055,698

(22) Filed: Nov. 15, 2022

(51) Int. Cl. G06N 20/20; G06K 9/62

(52) U.S. Cl. CPC G06N 20/20; G06K 9/6227; G06K 9/6262

(57) ABSTRACT

Finding accurate prediction objectives includes building, by a framework application, a data pool for each of a plurality of prediction objectives. A plurality of machine learning (ML) models is trained for each data pool, and each of the plurality of ML models is combined for each data pool. One or more accurate objectives are identified and selected on the basis of a performance of the combined plurality of ML models.

### FIELD

The present invention relates to lead scoring, and more particularly, to an objective detection in a multi-tenant lead scoring system.

### BACKGROUND

Lead scoring systems categorize and sort prospective customers (i.e., leads or sales opportunities) based on an estimated probability of conversion. Leads, for the purposes of explanation, is a collection of data that is used by a user to connect with an end consumer. However, in instances where the data is inaccurate or outdated, the ability of the user to connect with the end consumer decreases.

Customer Relationship Management (CRM) providers may build a rules- based or machine learning (ML)-based lead scoring methodology to predict certain stages (e.g., prediction objectives) in the lead funnel for a business (e.g., account). Different businesses use CRM software differently on the basis of their core business. Further, their primary focused objective can be on one or multiple stages (objectives) in the lead funnel. See the following example below.

Visitor→Lead→Engagement Initiation (Interest)→Qualified Lead→Customer→Negotiation→Paying Customer→Loyal Customer

This stage is configured manually by an admin of the account. The CRM system may then prepare a features generation pipeline and build the configured stage model. For instance, in traditional lead scoring system, the stage for the objectives is manually configured by the admin. This is not an area of focus for the sales agents and the best objective (e.g., stage-m→stage-n) may be computed using the underlying data itself. Put simply, the traditional manual approach is not aligned with the objective driven by data.

Thus, an alternative technique to eliminate inaccurate data or outdated data may be more beneficial.

### SUMMARY

Certain embodiments of the present invention may provide solutions to the problems and needs in the art that have not yet been fully identified, appreciated, or solved by current lead scoring technologies. For example, some embodiments of the present invention pertain to multi-tenant lead scoring addressing multiple problems that exists in customer relation management (CRM) systems. In one embodiment, objective detection is a framework that leverages machine learning (ML) to find the most accurate prediction objectives required for a given business and enable lead scoring more efficiently.

In one embodiment, a method for finding accurate prediction objectives includes building, by a framework application, a data pool for each of a plurality of prediction objectives. The method also includes training a plurality of machine learning (ML) models for each data pool, and combining each of the plurality of ML models for each data pool. The method further includes identifying and selecting one or more accurate objectives on the basis of a performance of the combined plurality of ML models.

In another embodiment, an apparatus is configured to find accurate prediction objectives. The apparatus includes memory comprising a set of instructions, and at least one processor. The set of instructions is configured to cause the at least one processor to execute building, by a framework application, a data pool for each of a plurality of prediction objectives, and training a plurality of machine learning (ML) models for each data pool. The set of instructions is further configured to cause at least one processor to execute combining each of the plurality of ML models for each data pool, and identifying and selecting one or more accurate objectives on the basis of a performance of the combined plurality of ML models.

In yet another embodiment, a non-transitory computer-readable medium comprises a computer program configured to find accurate prediction objectives. The computer program is configured to cause at least one processor to execute building, by a framework application, a data pool for each of a plurality of prediction objectives, and training a plurality of machine learning (ML) models for each data pool. The computer program is further configured to cause at least one processor to execute combining each of the plurality of ML models for each data pool, and identifying and selecting one or more accurate objectives on the basis of a performance of the combined plurality of ML models.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a flow diagram illustrating a method 100 for performing multi-tenant lead scoring on an end-to-end system, according to an embodiment of the present invention.

### DETAILED DESCRIPTION OF THE EMBODIMENTS

Some embodiments pertain to searching for accurate prediction objectives from the data of an account itself. For purposes of explanation, accurate prediction objective provides higher machine learning (ML) performance and is aligned with the nature of the enterprise. To achieve this, a framework application (hereinafter the “framework”) builds a data pool for each of the prediction objectives, and then trains three different ML models for each pool. For purposes of explanation, a data pool may be defined as the collection of all underlying data sets (i.e., static, dynamic, email, notes, voice, etc.) and dependent variable (e.g., win/loss together), which are a combined view at the lead level for each stage pair (i.e., ˜objective). This combined view may be used for ML training. The framework may then use an ensemble approach to combine three ML models. Eventually, the framework identifies and selects the accurate objectives on the basis of the ML models' (i.e., the combined ML models) performance.

Additionally, the framework creates target variables for each of the objectives—explicit and implicit tagging, which helps to enhance the data quality and thereby improving performance.

The framework ‘Objective Detection’ includes the following steps — data preparation, account category, data enrichment (for static model) and feature engineering, pooling, model building, ensemble method, and best model selection and prediction objective detection.

### DATA PREPARATION

Under data preparation, the raw data is extracted from a CRM database (not shown) and a functional data set is prepared for possible prediction objectives. In some embodiments, raw data is defined as a collection of information as gathered by the source but before the raw data has been further processed, cleaned or analyzed. For example, static information (i.e., first name, last name, email, job title, etc.) entered by a CRM lead during the signup process, micro-level details about the conversation happened between agent-leads (e.g., email sent-received with timestamp), and uncleaned HTML version of exchanged emails. For instance, data cleaning and transformations for the static, dynamic and semantic featured fields are used in model building.

To prepare a functional data set, a number of operations should be executed. First, under data collection, all information (e.g., raw static fields, interaction data, email data, notes, etc.) related to a lead is gathered as a single record. In some embodiments, enrichment for data collection and enhancing data quality may also be used.

Next, under the cleaning step, lower case formatting, tokenization, stemming, date formatting, etc., are performed on each record in the data. After that, under mapping, different abbreviations of the same countries and job titles are mapped to a single correct name. Examples include mapping US, USA, U.S.A, United States, etc. to the United States of America; and mapping CEO and Chief Executed Officer & Founder to Chief Executive Officer. Lastly, feature engineering may be used in ML model training.

It should be noted that there may be different types of attributes in different ML based models. Type of attributes may include static (e.g., demographics, job title, company size, company revenue, funding, industry, purchase authority, etc.), dynamic (e.g., agent-leads interaction data—call/email/events, etc.), social data (e.g., Facebook ®/Twitter ®/Linkedln ®, etc.), and exchanged text email, to name a few.

In some embodiments, the framework uses two types of methodologies to create outcome variable for each prediction objective. The first one is explicit method and the second is implicit method.

Under explicit method, leads (those that are marked lost or won by the sales agent explicitly) are examined and the framework assigns a 0 for lost leads and a 1 for converted leads.

Under implicit method, a time-based approach is used and those leads, which are inactive for a very long time, are examined. In some embodiments, the percentiles (e.g., 96, 97, 98 or 99) of the closing time (closed-create) are calculated for all the closed leads in the accounts and are used to mark inactive leads as lost (e.g., for paid customer objectives, for many accounts it comes as 120-150). The framework calculates an estimated time (e.g., est_days_to_close) required to close a lead for a given account. The framework then marks these obsolete leads as lost when the obsolete leads are inactive for the adequate time greater than est_days_to_close.

### Account Category

The framework assigns multiple categories to a given account with the help of data available and how the account is using CRM. It should be noted that the category is a function of number of closed leads and lead winning rate (i.e., how many winning leads from all the closed leads) may be marked by the sales agents.

In some embodiments, an account has one of the three following categories corresponding to each prediction objective — indecisive, blurry, and limpid.

Under undecisive, a very low strength objective is tagged and the very low strength objective represents the need of requiring more data to make a decision about the account's objective.

Under blurry, a small or mid strength objective is tagged. The tagged small or mid strength objective may be a good start to make a decision about the account's prediction objective. The small or mid strength objective also has a few more subcategories that are used to add more insights to decide about the prediction objective.

Under limpid, a clear go-ahead about the prediction objective is shown. This also has few subcategories to help with the decision whether the pooling is required or not.

### Data Enrichment

The framework leverages enrichment from multiple vendors, such as Clearbit™ and fullContact™, to name a few, to improve the existing static CRM data as well to add more insight about the lead person and demographic attributes. In some embodiments, data enrichment is a process of enhancing existing information by supplementing missing or incomplete data. Typically, data enrichment is achieved by using external data sources (e.g., Clearbit™, Fullcontct™, etc.). In this example, if some leads have not provided some personal information, such as job or title during their signup, data enrichment is activated to complete the process using a provided email identification.

The framework execute extensive features, thereby engineering for all kinds of raw features and for each possible prediction objective to build the different ML models. As discussed above, raw data is the collection of information as gathered by the source before the raw data has been further processed, cleaned or analyzed. Static information (e.g., first name, last name, email, job title, etc.) is information entered by a CRM lead during the signup process or is micro level information (e.g., email sent/received information with given timestamp). The feature set includes many types of features — priors and quality of the lead. A prior is a conversion rate for a given variable (e.g., job title) and given value (e.g., CTO) for all the closed leads in the past. In one example, for all leads having CTO as a job title, the prior is equal to the percentage of how many of leads are actually won. The quality of the leads is how much information is available about lead's persona and demographic details.

All the features are aggregated at different levels, e.g., global, county, region, industry, etc.

### Pooling

The framework determines if data pooling is required for a given small account and for a given objective with the help of categories mentioned in account category. This may include accounts having few closed leads, which is used to build the ML model. Objective is the probability estimation of a given lead from one stage to another next stage. The global/region/country/industry specific features may be calculated with the concept of pooling. The similar industry's accounts club together for each industry (e.g., SAAS, finance, retail, etc.) and they produce a joint prior base features used in ML model. The same aggregation also happened at country, region and global labels. The framework pools more data from a similar set of accounts to build a robust and correct model for smaller accounts. Robust may be defined as a model having maximum ML performance (e.g., higher AUC). In such embodiments, the framework does not share any persona information (PI) or actual data between accounts. Instead, the framework computes aggregated ML features, which are not visible to end users.

An AUC-ROC curve is a performance measurement for the classification problems at various threshold settings. Receiver Operator Characteristic (ROC) is a probability curve and Area under the ROC Curve (AUC) represents the degree or measure of separability. The AUC and ROC illustrates how much the model is capable of distinguishing between classes. Higher the AUC, the better the model is at predicting 0 classes as 0 and 1 classes as 1.

Aggregated ML feature are aggregated or prior conversion rate for a given field. For example, on an average how many replied emails are required to become a customer in the underlying industry. In another example, if the job title is Director, what is the prior conversion rate in the underlying industry?

### Model Building

Under model building, the framework uses multiple models to capture content (or context) from different sources/classes of features. In some embodiments, 2 non-linear ML algorithms—balanced random forest and XGBoost models—are used to capture non-linear relationships among all the features.

In one example, the framework uses a static or fit model, interest or behavioral model, and/or semantic model. Under the static or fit model, static signals are leveraged. The static signals generally pertain to the lead sourced from external enrichment partners. This may include demographics, job title, company size, company revenue, funding, industry, purchase authority, etc.

Under the interest or behavior model, activities performed by the lead that are on application/website, engagement, etc., are leveraged. Such activities may include frequency/recency patterns in communication via emails, chat sessions, voice calls, web visits, appointments, etc.

Under semantic model, this model leverages text/voice conversations between the lead and the business. For example, emails, agent notes, transcribed voice, chat text, etc., are some of the main signals that go to this model.

The frameworks use imbalanced Random Forest approach (and XGBoost model) to build these multiple ML models for different objectives with and/or pooling. The imbalanced Random Forest is designed to tune hyper-parameters automatically on the basis of scoring performance, class imbalance (if any), and data availability.

### Ensemble Engine

The framework has an ensemble engine configured to combines the selected ML models (e.g., static model, behavior model, and semantic model) and produce a single ML score corresponding to each lead in the account. The random forest is a non- linear method and in the proposed lead scoring framework it performs better than any other available linear or nonlinear methods.

In some embodiments, weights are calculated from the validation data set during ML model training. Validation data set may be defined as a sample of data held back from training the ML model, which is used to give an estimate of model skill while tuning model's hyperparameters. This approach maximizes the model performance on validation data set by selecting the different weights at different times of the leads journey.

Best Model Selection and Prediction Objective Detection

The framework picks the final set of models on the basis of best use case as well as model performance from all the built models. Best use case may be determined on the ML performance in some embodiments. The framework uses AUC, Recall and Precision to compute the performance for each of the built models and prediction objectives.

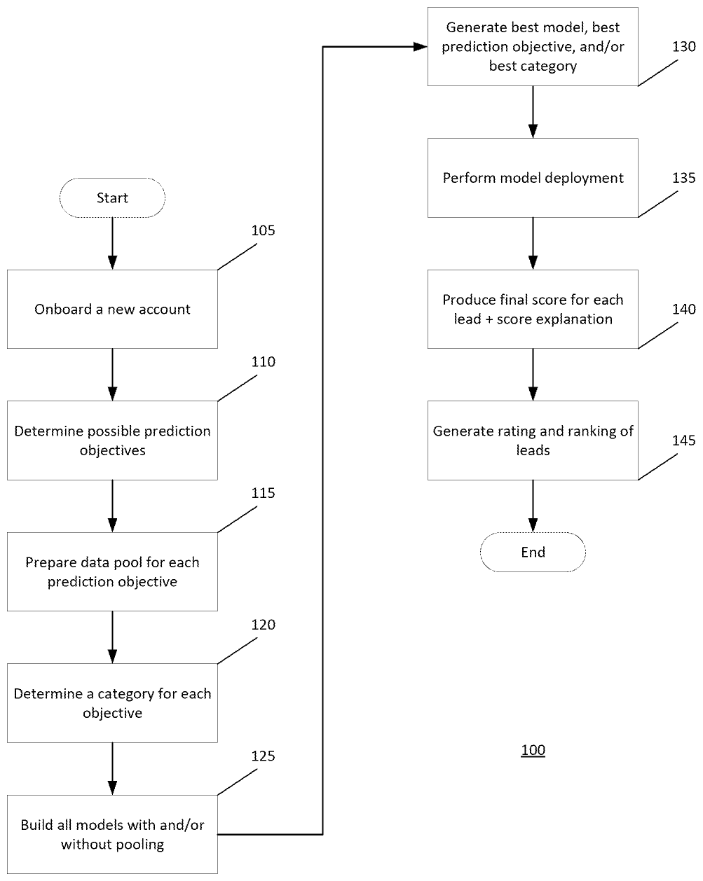

FIG. 1 is a flow diagram illustrating a method 100 for performing multi-tenant lead scoring on an end-to-end system, according to an embodiment of the present invention. In FIG. 1 , method 100 includes onboarding a new account 105. This includes past lead data (if available), configured lead matching rules by the admin, etc. Method 100 further includes determining possible prediction objectives at 110, and for each prediction objective that is determined, preparing a data pool at 115.

Method 100 includes determining a category for each prediction objective on the basis of dependent variable (DV) or target variable (TV) and data available at 120. Method 100 further includes building all models with and without pooling at 125. This includes incorporating pooling and data enrichment processes. Method 100 continues with identifying the best model, best prediction objective, and the best category at 130.

Method 100 includes model deployment at 135. Within model deployment, there are several steps as outlined below.

### Model Training and Metadata Generation Pipeline

This pipeline determines the best prediction objective by building different models for each new account and eventually produces a metadata comprising information about the final model, chosen prediction objective, performance, pooling flag, category, etc., for each account. The pipeline also stores the final production models in a S3 location.

### Copy Models to Production Sagemaker™ Machine

In some embodiments, a job is setup to copy and update the models, priors and metadata to the production environment for further use. This embodiment is executed after each training pipeline completion.

### Process Rules and Generate Weights to Each of the Models

In some embodiments, the explicit rules (configured by the admin) are consumed in each account and a weight is assigned to each rule using a mathematical algorithm.

### Prepare Payload Input for Online Prediction

Whenever a new lead payload (e.g., created/updates) comes into the production, the system prepares an input for online production. This includes data preparation, adding admin rules information with weights, etc. The system makes use of the metadata to find the correct model for the account.

The system may then invoke an online inference module to generate the lead prediction using fit/interest/email model. The system continues with generating percentile, rating and interpretability for each prediction. The system may also match and generate explicit rules base scores and eventually combines the ML score with it.

### Push Generated Score and Interpretability to Redis

The output of the online inference module is written to a Redis cluster which is used in product user interface (UI).

### Model Retraining

The system runs a daily job to retrain production models and priors for each account. Whenever there is a change in any accounts' model or priors, the system updates the same in the production and also makes the changes in the metadata accordingly.

Returning to FIG. 1, method 100 includes generating a final score for each lead and a message explaining the score at 140. Method 100 also includes generating a customer rating and ranking of leads at 145.

The process steps performed in FIG. 1 may be performed by a computer program, encoding instructions for the processor(s) to perform at least part of the process(es) described in FIG. 1, in accordance with embodiments of the present invention. The computer program may be embodied on a non-transitory computer- readable medium. The computer-readable medium may be, but is not limited to, a hard disk drive, a flash device, RAM, a tape, and/or any other such medium or combination of media used to store data. The computer program may include encoded instructions for controlling processor(s) of a computing system to implement all or part of the process steps described in FIG. 1, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a modified computing system.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A method for finding accurate prediction objectives, comprising:
building, by a framework application, a data pool for each of a plurality of prediction objectives;
training a plurality of machine learning (ML) models for each data pool;
combining each of the plurality of ML models for each data pool; and
identifying and selecting one or more accurate objectives on the basis of a performance of the combined plurality of ML models.

2. The method of claim 1, wherein the plurality of prediction objectives is a probability estimation of a given lead from one stage to another stage.

3. The method of claim 1, wherein each data pool comprising a composition of an underlying data sets and a dependent variable.

4. The method of claim 1, wherein the training of the plurality of ML models comprises:
performing raw data cleaning, wherein performing the raw data cleaning comprises number and string formatting, conversion to lower case, removal of unwanted information, and missing value imputation,
performing transformation, wherein performing the transformation comprises identification to name mappings for desired columns, map country, job title, state, and city values to correct form values, and aggregate information at lead level,
performing enrichment, wherein the performing the enrichment comprises querying third party vendor for a given corporate lead email using an application programming interface (API), accessing and processing response API JSON data, clean received JSON data, and update and add new information to lead customer resource management (CRM) attributes,
performing feature extraction, wherein the performing feature extraction comprises generating multiple independent variables and lead base features, the independent variables comprising prior calculations at account level, global level, country level, and industry level, and the lead base features comprising email type and spam detection,
performing model hyper-parameter tuning, wherein the model hyper-parameter tuning comprises performing grid search for number of tress, max depth, and max number of features, and
performing training of the ML model, wherein performing the training of the ML model comprises building a ML model on a training set and validate the ML model on the validation data sets.

5. The method of claim 1, wherein the one or more accurate objectives is validated data to build the models with maximum performance among all available objectives.

6. The method of claim 5, wherein the identifying and selecting of the one or more accurate objectives comprises:
identifying a model to be selected among a plurality of models using permanence metrics, wherein
the permanence metrics comprises an Area under a Receiver Operator Characteristic (ROC) Curve (AUC).

7. The method of claim 1, further comprising:
calculating an Area under a Receiver Operator Characteristic (ROC) Curve (AUC) for each of the plurality of models on a validation data set.

8. An apparatus configured to find accurate prediction objectives, comprising:
memory comprising a set of instructions, and
at least one processor, wherein
the set of instructions is configured to cause the at least one processor to execute
building, by a framework application, a data pool for each of a plurality of prediction objectives;
training a plurality of machine learning (ML) models for each data pool;
combining each of the plurality of ML models for each data pool; and
identifying and selecting one or more accurate objectives on the basis of a performance of the combined plurality of ML models.

9. The apparatus of claim 8, wherein the plurality of prediction objectives is a probability estimation of a given lead from one stage to another stage.

10. The apparatus of claim 8, wherein each data pool comprising a composition of an underlying data sets and a dependent variable.

11. The apparatus of claim 8, wherein the set of instructions is configured to cause the at least one processor to execute
performing raw data cleaning, wherein performing the raw data cleaning comprises number and string formatting, conversion to lower case, removal of unwanted information, and missing value imputation,
performing transformation, wherein performing the transformation comprises identification to name mappings for desired columns, map country, job title, state, and city values to correct form values, and aggregate information at lead level,
performing enrichment, wherein the performing the enrichment comprises querying third party vendor for a given corporate lead email using an application programming interface (API), accessing and processing response API JSON data, clean received JSON data, and update and add new information to lead customer resource management (CRM) attributes,
performing feature extraction, wherein the performing feature extraction comprises generating multiple independent variables and lead base features, the independent variables comprising prior calculations at account level, global level, country level, and industry level, and the lead base features comprising email type and spam detection,
performing model hyper-parameter tuning, wherein the model hyper-parameter tuning comprises performing grid search for number of tress, max depth, and max number of features, and
performing training of the ML model, wherein performing the training of the ML model comprises building a ML model on a training set and validate the ML model on the validation data sets.

12. The apparatus of claim 8, wherein the one or more accurate objectives is validated data to build models with maximum performance among all available objectives.

13. The apparatus of claim 12, wherein the set of instructions is configured to cause the at least one processor to execute
identifying a model to be selected among a plurality of models using permanence metrics, wherein
the permanence metrics comprises an Area under a Receiver Operator Characteristic (ROC) Curve (AUC).

14. The apparatus of claim 8, wherein the set of instructions is configured to cause the at least one processor to execute
calculating an Area under a Receiver Operator Characteristic (ROC) Curve (AUC) for each of the plurality of models on a validation data set.

15. A non-transitory computer-readable medium comprising a computer program configured to find accurate prediction objectives, wherein the computer program is configured to cause at least one processor to execute:
building, by a framework application, a data pool for each of a plurality of prediction objectives;
training a plurality of machine learning (ML) models for each data pool;
combining each of the plurality of ML models for each data pool; and
identifying and selecting one or more accurate objectives on the basis of a performance of the combined plurality of ML models.

16. The non-transitory computer-readable medium of claim 15, wherein the plurality of prediction objectives is a probability estimation of a given lead from one stage to another stage.

17. The non-transitory computer-readable medium of claim 15, wherein each data pool comprising a composition of an underlying data sets and a dependent variable.

18. The non-transitory computer-readable medium of claim 15, wherein the computer program is further configured to cause at least one processor to execute
performing raw data cleaning, wherein performing the raw data cleaning comprises number and string formatting, conversion to lower case, removal of unwanted information, and missing value imputation,
performing transformation, wherein performing the transformation comprises identification to name mappings for desired columns, map country, job title, state, and city values to correct form values, and aggregate information at lead level,
performing enrichment, wherein the performing the enrichment comprises querying third party vendor for a given corporate lead email using an application programming interface (API), accessing and processing response API JSON data, clean received JSON data, and update and add new information to lead customer resource management (CRM) attributes,
performing feature extraction, wherein the performing feature extraction comprises generating multiple independent variables and lead base features, the independent variables comprising prior calculations at account level, global level, country level, and industry level, and the lead base features comprising email type and spam detection,
performing model hyper-parameter tuning, wherein the model hyper-parameter tuning comprises performing grid search for number of tress, max depth, and max number of features, and
performing training of the ML model, wherein performing the training of the ML model comprises building a ML model on a training set and validate the ML model on the validation data sets.

19. The non-transitory computer-readable medium of claim 15, wherein the one or more accurate objectives is validated data to build models with maximum performance among all available objectives.

20. The non-transitory computer-readable medium of claim 19, wherein the computer program is further configured to cause at least one processor to execute
identifying a model to be selected among a plurality of models using permanence metrics, wherein
the permanence metrics comprises an Area under a Receiver Operator Characteristic (ROC) Curve (AUC); and
calculating AUC for each of the plurality of models on a validation data set.
